(19) United States
(12) Patent Application Publication
(10) Pub. No.: US 2017/0118113 A1
(43) Pub. Date: Apr. 27, 2017

(54) SYSTEM AND METHOD FOR PROCESSING DATA PACKETS BY CACHING INSTRUCTIONS

(71) Applicant: Freescale Semiconductor, Inc., Austin, TX (US)

(72) Inventors: JYOTHI VEMULAPALLI, Hyderabad (IN); SRINIVASA R. ADDEPALLI, San Jose, CA (US); RAKESH KURAPATI, Hyderabad (IN)

(21) Appl. No.: 14/924,683

(22) Filed: Oct. 27, 2015

(51) Int. Cl. H04L 12/747; H04L 12/741

(52) U.S. Cl. CPC H04L 45/742; H04L 45/745

(57) ABSTRACT

A system for processing data packets includes memories with cache buffers that store flow tables and a flow index table, and a processor in communication with the memories. When the processor receives a data packet, it determines whether the flow index table includes a flow index table entry corresponding to the data packet. If the flow index table includes the required flow index table entry, the processor fetches cached instructions corresponding to the data packet from the flow index table and processes the data packet using the fetched instructions. If the flow index table does not include a flow index table entry for the data packet, then the processor fetches the instructions from the flow tables and stores these instructions in the cache buffers, thereby caching the instructions in the flow index table.

### BACKGROUND

The present invention relates generally to communication networks, and, more particularly, to a system for processing data packets in a communication network.

A communication network typically includes multiple digital systems such as gateways, switches, access points and base stations that manage the transmission of data packets in the network. A digital system includes a memory that stores flow tables and a processor, which receives the data packets and processes them, based on instructions stored in the flow tables.

When the processor receives a data packet, it scans the memory in a sequential manner for a flow table having a flow table entry for the data packet. Instructions stored in the flow table entry may direct the processor to other flow tables that include instructions corresponding to the data packet. The processor then processes the data packet based on the instructions. Thus, the processor performs multiple memory accesses to fetch instructions corresponding to the data packet. This increases the packet processing time. Further, the sequential scanning of the memory until a flow table having a flow table entry for the data packet is identified adds to the packet processing time.

It would be advantageous to reduce the number of memory accesses needed to fetch packet processing instructions and thereby reduce the packet processing time.

### BRIEF DESCRIPTION OF THE DRAWINGS

The following detailed description of the preferred embodiments of the present invention will be better understood when read in conjunction with the appended drawings. The present invention is illustrated by way of example, and not limited by the accompanying figures, in which like references indicate similar elements.

FIG. 1 is a schematic block diagram of a system that processes data packets in accordance with an embodiment of the present invention;

FIG. 2 is a schematic block diagram of a set of memories of the system of FIG. 1 that stores flow tables and a flow index table in accordance with an embodiment of the present invention;

FIG. 3 is a structure of a flow table entry of a flow table stored in a memory of FIG. 2 in accordance with an embodiment of the present invention;

FIG. 4 is a structure of a flow index table entry of the flow index table of FIG. 2 in accordance with an embodiment of the present invention; and

FIGS. 5A, 5B, and 5C are a flow chart illustrating a method for processing data packets in accordance with an embodiment of the present invention.

### DETAILED DESCRIPTION

The detailed description of the appended drawings is intended as a description of the currently preferred embodiments of the present invention, and is not intended to represent the only form in which the present invention may be practiced. It is to be understood that the same or equivalent functions may be accomplished by different embodiments that are intended to be encompassed within the spirit and scope of the present invention.

In an embodiment of the present invention, a system for processing data packets is provided. The system includes a set of memories that stores a set of flow tables and a flow index table. Each flow table includes flow table entries. The set of memories also includes a set of cache buffers. The flow index table includes flow index table entries. A processor is in communication with the set of memories. The processor receives a data packet and determines whether the flow index table includes a flow index table entry corresponding to the data packet. The processor fetches an instruction that corresponds to the data packet from the flow index table entry when the flow index table includes the required flow index table entry and processes the data packet based on the cached instruction. The instruction is cached in one or more cache buffers.

In another embodiment of the present invention, a method for processing data packets by a network device is provided. The network device includes a set of memories that stores a set of flow tables and a flow index table. The set of memories includes a set of cache buffers. Each flow table includes flow table entries. The flow index table includes flow index table entries. The method comprises receiving a data packet and determining whether the flow index table includes a flow index table entry corresponding to the data packet. The method further comprises fetching an instruction that corresponds to the data packet using the flow index table entry when the flow index table includes the required flow index table entry. The instruction is cached in one of the cache buffers. The method further comprises processing the data packet using the fetched instruction.

Various embodiments of the present invention provide a system for processing data packets. The system includes a set of memories that stores flow tables and a flow index table. The set of memories also includes cache buffers, which store instructions. A processor in communication with the set of memories receives a data packet and determines whether the flow index table includes a flow index table entry that corresponds to the data packet. If yes, the processor fetches cached instructions corresponding to the data packet from the cache buffers and processes the data packet using the fetched instructions. These instructions are included in the flow index table entry. If the flow index table does not include the required flow index table entry, the processor fetches instructions from the flow tables and stores the fetched instructions in the cache buffers, thereby caching the instructions in the flow index table for future use. The processor may execute the instructions after fetching or storing them.

Since the instructions are cached in the cache buffers, instructions corresponding to a data packet can be fetched directly from the cache buffers. A flow index table entry corresponding to the data packet includes these instructions. The flow index table entry may even store a pointer to the address of the cache buffers that store the instructions. Thus, the number of memory accesses required for processing the data packet is decreased, which reduces the processing time of the data packet and increases the throughput of the communication network.

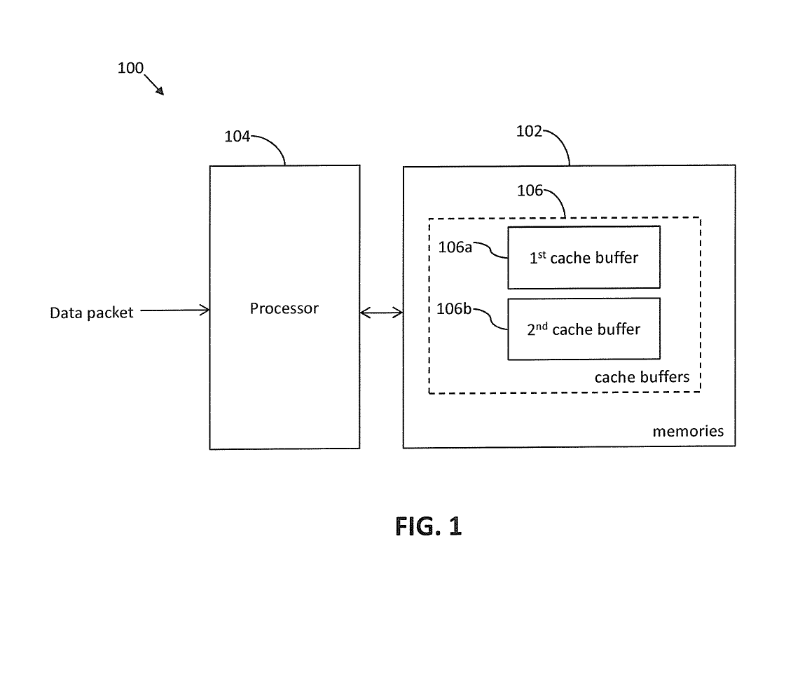

Referring now to FIG. 1, a schematic block diagram of a system 100 for processing data packets in accordance with an embodiment of the present invention is shown. The system 100 is a part of a communication network (not shown). Examples of the system 100 include gateways, switches, access points, and base stations. The system 100 includes a set of memories 102 (two or more) and a processor 104 in communication with the memories 102. The processor 104 receives and processes data packets. The memories 102 include one or more cache buffers 106, two of which are shown in this embodiment—first and second cache buffers 106a and 106b. However, it should be understood by those with skill in the art that the memory 102 can include any number of the cache buffers 106.

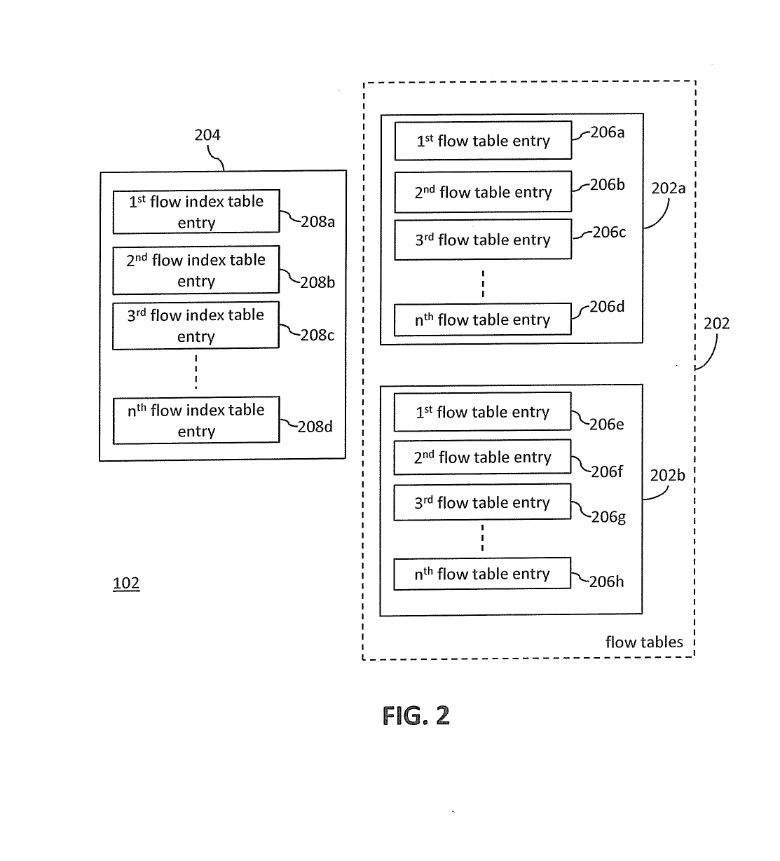

Referring now to FIG. 2, a schematic block diagram of the memories 102 in accordance with an embodiment of the present invention is shown. The memories 102 include a plurality of flow tables 202, with first and second flow tables 202a and 202b being shown. The memories 102 also includes a flow index table 204. Each flow table 202 includes multiple flow table entries 206. For example, the first flow table 202a includes first through fourth flow table entries 206a-206d and the second flow table 202b includes fifth through eighth flow table entries 206e-206h. The flow index table 204 includes multiple flow index table entries 208 including first through fourth flow index table entries 208a-208d. It will be understood by those with skill in the art that the flow tables 202 and the flow index table 204 may be spread across more than one memory of the set of memories 102. For example, the flow tables 202 may be stored in one memory and the flow index table 204 stored in another memory. Depending on the size, a flow table 202 itself may be spread across multiple memories. Similarly, the flow index table 204 may be spread across multiple memories 102. Examples of the memories 102 include static random-access memories (RAMs), dynamic RAMs (DRAMs), read-only memories (ROMs), flash memories, and register files.

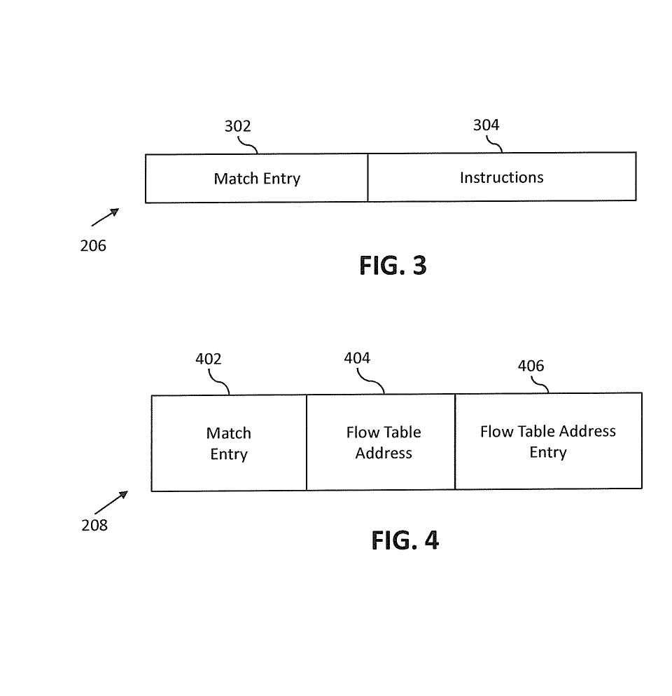

Referring now to FIG. 3, a structure of a flow table entry 206 in accordance with an embodiment of the present invention is shown. Each flow table entry 206 includes a match entry field 302 for storing a match entry of a data packet and an instruction field 304 for storing instructions corresponding to the data packet. Examples of a match entry include a source Internet Protocol (IP) address, a destination IP address, a source Media Access Control (MAC) address, and a destination MAC address.

FIG. 4 shows the structure of a flow index table entry 208 in accordance with an embodiment of the present invention. Each flow index table entry 208 includes a match entry field 402 for storing a match entry of a data packet, a first address field 404 for storing a flow table address, which includes a flow table entry (206) corresponding to the data packet, and a second address field 406 for storing a flow table entry address. In one embodiment, portions of the flow index table entry 208 are stored in different memories 102. In this case, the flow index table entry 208 may include a pointer to the address of the memory location that stores the second portion of the flow index table entry 208. Further, instructions included in a flow index table entry 208 can be stored in more than one of the cache buffers 106. Thus, the flow index table entry 208 may include a field to store the address of the cache buffers 106. In one embodiment, the instructions are stored in the cache buffers 106 in a type, length and data format (i.e., a type of an instruction, a length of the instruction, and data corresponding to the instruction). For example, in a Software-Defined Network (SDN), instructions are of six types, viz., an experimental instruction, a write-action instruction, a metadata instruction, a meter instruction, and a clear-action instruction. The instruction length refers to its size. Data corresponding to an instruction may include a pointer to a set of actions corresponding to the instruction. The processor 104 may directly store actions corresponding to an instruction in the cache buffers 106 instead of storing the instruction. These actions may be stored in the cache buffers 106 in type, length and data format. In an SDN, an apply-action instruction is one such instruction for which the processor 104 may store a corresponding set of apply actions instead of the apply-action instruction. Further, the type value of an apply action may be modified if it coincides with a type value of an instruction. For example, the type value of either the experimenter action or experimenter instruction is modified, so that the type values of the experimenter action and the experimenter instruction do not coincide with each other.

The processor 104 identifies a flow table entry 206 corresponding to a data packet by matching a match entry included in the data packet with the match entry 302 in the flow table entry 206. Similarly, the processor 104 identifies a flow index table entry 208 corresponding to a data packet by matching a match entry included in the data packet with the match entry 402 in the flow index table entry 208.

In operation, when the processor 104 receives a data packet, the processor 104 determines whether the flow index table 204 includes a flow index table entry 208 corresponding to the data packet. If the flow index table 204 includes the flow index table entry 208, the processor 104 fetches the instructions from the flow index table entry 208 and processes the data packet using the fetched instructions. Processing the data packet includes, but is not limited to, modification of a field of the data packet, insertion of a new field in the data packet, deletion of a field of the data packet, pushing of the data packet on to a stack, and forwarding of the data packet to a destination node. In an SDN, the flow index table entry 208 may include apply actions and other instructions that correspond to the received data packet. Thus, the processor 104 fetches the apply actions and the instructions, and executes them.

If the flow index table 204 does not include the required flow index table entry 208, the processor 104 scans the memories 102 for a flow table 202 that includes a flow table entry 206 corresponding to the data packet. The processor 104 then fetches the instructions from the flow table entry 206 and stores the fetched instructions in the cache buffers 106, thereby caching the instructions in the flow index table 204. If the flow table entry 206 includes a pointer to the memory addresses where the instructions corresponding to the data packet are stored, then the processor 104 fetches these instructions and stores them in the flow index table 204. The processor 104 then processes the data packets using the fetched instructions. The processor 104 may execute an instruction before storing it in the flow index table 204. Further, the processor 104 does not store redundant instructions in the cache buffers 106. An example of a redundant instruction is a goto instruction. In an SDN, if a flow table entry 206 includes an apply-action instruction corresponding to the received data packet, the processor 104 fetches actions corresponding to the apply-action instruction instead of the apply-action instruction itself and stores the fetched apply actions in the cache buffers 106. The processor 104 processes the data packet based on these actions and other instructions that correspond to the data packet. Further, as mentioned above, the apply-actions may have modified type values so that the type values do not match with the type values of instructions.

The processor 104 deletes a flow index table entry 208 when a flow table entry 206 corresponding to the flow index table entry 208 is marked for deletion. For example, when a controller (not shown) sends a flow table entry deletion message, then that flow table entry 206 is marked for deletion by the processor 104. The processor 104 may also mark a flow table entry 206 for deletion when a count value associated with the entry 206 is greater than a predetermined value. When a flow index table entry 208 is deleted, the processor 104 decrements a flow entry reference count that indicates the total number of references pointing to the flow table entry 206. The flow entry reference count may be stored in the memory 102 or a register (not shown).

A flow table 202 may include table-miss flow entries. A table-miss flow entry includes instructions for a data packet that are to be performed on the data packet if the flow table 202 and the flow index table 204 do not have any matching flow table entries 206 for the data packet (i.e., if there is a table-miss for the data packet). However, if there is no table-miss flow entry corresponding to the data packet in the flow table 202, the data packet is dropped.

In one embodiment, a write-action set is associated with a data packet when a flow table entry 206 corresponding to the data packet includes a write-action instruction. The write-action set includes instructions that are to be executed by the processor 104 on a data packet when the processor 104 has completed fetching all the instructions corresponding to the data packet. For example, in an SDN, if the instruction fetched is a write-action instruction, the processor 104 stores a set of actions associated with the write-action instruction in the write-action set. The processor 104 executes the instructions of the write-action set after all the instructions for the data packet are fetched.

As the instructions are cached in the cache buffers 106, instructions corresponding to a data packet can be directly fetched by the processor 104 from the cache buffers 106. A flow index table entry 208 corresponding to the data packet includes these cached instructions. The flow index table entry 208 may also store a pointer to the address of the cache buffers 106 where the instructions are stored. Thus, the number of memory accesses required to process the data packet is decreased. This reduces the data packet processing time and increases the throughput of the communication network.

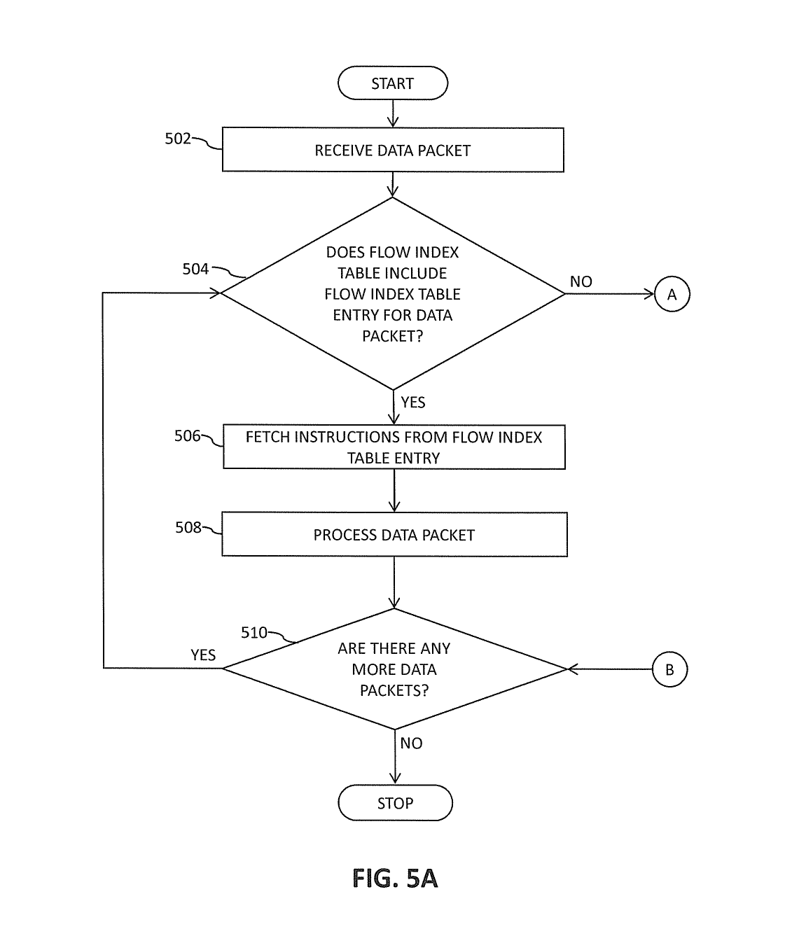

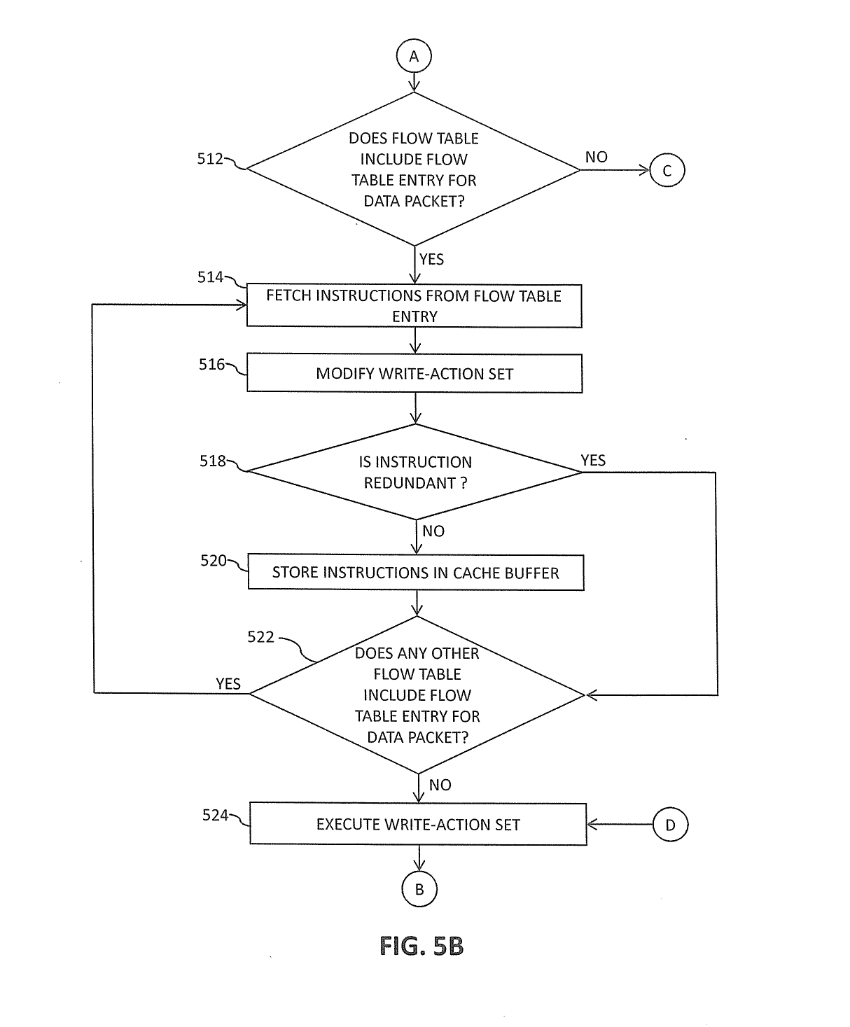

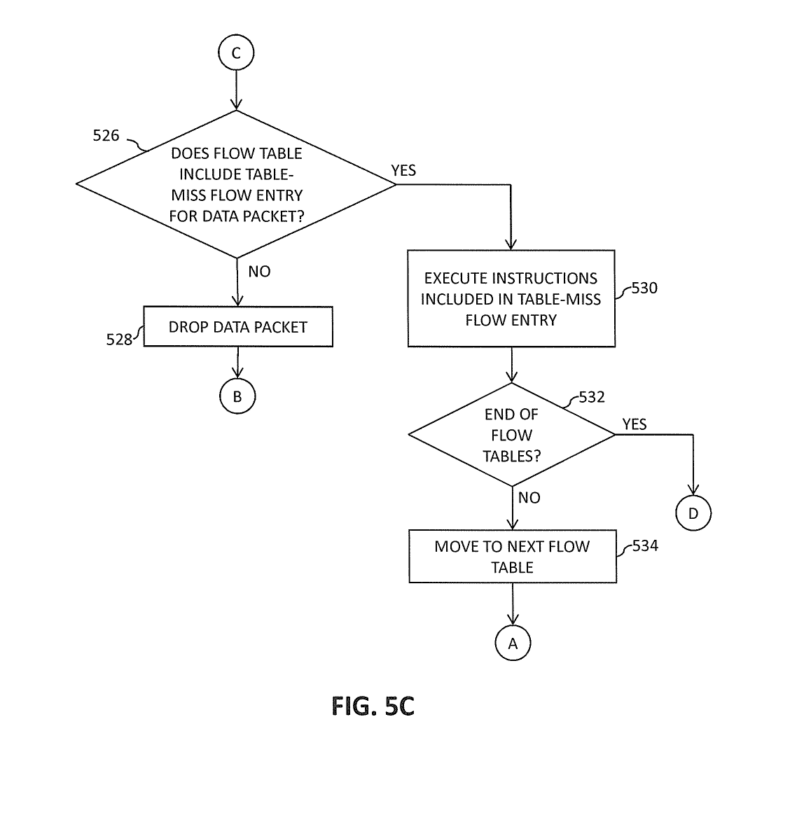

Referring now to FIGS. 5A, 5B, and 5C, a flow chart illustrating a method for processing data packets in accordance with an embodiment of the present invention is shown. At step 502, the processor 104 receives a data packet. At step 504, the processor 104 determines whether the flow index table 204 includes a flow index table entry 208 corresponding to a data packet. If, at step 504, the processor 104 determines that the flow index table 204 does not include the required flow index table entry 208, the processor 104 executes step 512. At step 506, the processor 104 fetches instructions from the flow index table entry 208. At step 508, the processor 104 processes the data packet based on the fetched instructions. At step 510, the processor 104 determines whether there are more data packets to be processed. If there are more data packets, the processor 104 executes step 504. At step 512, the processor 104 determines whether a flow table 202 includes a flow table entry 206 corresponding to the data packet. If, at step 512, the processor 104 determines that the flow table 202 does not include the required flow table entry 206, the processor 104 executes step 526. At step 514, the processor 104 fetches the instructions from the flow table entry 206. At step 516, the processor 104 modifies the write-action set, based on the fetched instructions. At step 518, the processor 104 determines whether the instructions are redundant. If, at step 518, the processor 104 determines that an instruction is redundant, the processor 104 executes step 522. At step 520, the processor 104 stores the instructions in the cache buffers 106, thereby caching the instructions in the flow index table 204. At step 522, the processor 104 determines whether any other flow table 202 includes flow table entries 206 corresponding to the data packet. If, at step 522, the processor 104 determines that the flow tables 202 include the required flow table entries 206, the processor 104 executes step 514. At step 524, the processor 104 executes the write-action set (if there is a write-action instruction for the data packet) and then executes step 510. At step 526, the processor 104 determines whether the flow table 202 includes a table-miss flow entry for the data packet. If, at step 526, the processor 104 determines that the flow table 202 includes the required table-miss flow entry, the processor 104 executes step 530. At step 528, the processor 104 drops the data packet and then executes step 510. At step 530, the processor 104 executes the instruction in the table-miss flow entry. At step 532, the processor 104 determines whether it has reached the end of flow tables 202 (i.e., the end of the flow table pipeline). If, at step 532, the processor 104 determines that it has reached the end of flow tables 202, the processor 104 executes step 524. At step 534, the processor 104 moves to the next flow table 202 in the pipeline and executes step 512.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims. Further, the phrase “based on” is intended to mean “based, at least in part, on” unless explicitly stated otherwise.

1. A system for processing a data packet, the system comprising:
a set of memories that includes a set of cache buffers, wherein the set of memories stores a flow index table and a set of flow tables, and wherein each flow table includes flow table entries, and wherein the flow index table includes a set of flow index table entries; and
a processor in communication with the memories, wherein the processor is configured to:
receive the data packet,
determine whether the flow index table includes a first flow index table entry of the set of flow index table entries, wherein the first flow index table entry corresponds to the data packet,
fetch a first instruction corresponding to the data packet when the flow index table includes the first flow index table entry, wherein the first flow index table entry includes the first instruction, and wherein the first instruction is stored in the cache buffers, and
process the data packet based on the first instruction.

2. The system of claim 1, wherein the processor is further configured to:
identify a first flow table of the set of flow tables when the flow index table does not include the first flow index table entry, wherein the first flow table includes a first flow table entry corresponding to the data packet,
fetch a second instruction corresponding to the data packet from the first flow table entry,
store the second instruction in the cache buffers, and
process the data packet based on the second instruction.

3. The system of claim 2, wherein the cache buffers store a type of each of the first and second instructions, a length of each of the first and second instructions, and data corresponding to each of the first and second instructions.

4. The system of claim 2, wherein the processor stores the second instruction in the cache buffers when the second instruction is not redundant.

5. The system of claim 1, wherein the processor determines whether the flow index table includes the first flow index table entry based on a match entry that corresponds to the data packet, and wherein the first flow index table entry includes the match entry.

6. A method for processing a data packet by a network device, wherein the network device includes a set of memories that store a flow index table and a set of flow tables, wherein each flow table includes flow table entries, and wherein the flow index table includes a set of flow index table entries, the method comprising:
receiving the data packet by the network device;
determining whether the flow index table includes a first flow index table entry of the set of flow index table entries, wherein the first flow index table entry corresponds to the data packet;
fetching a first instruction corresponding to the data packet when the flow index table includes the first flow index table entry, wherein the first instruction is included in the first flow index table entry and stored in a cache buffer, and wherein the memories include the cache buffer; and
processing the data packet based on the first instruction.

7. The method of claim 6, further comprising:
identifying a first flow table of the set of flow tables when the flow index table does not include the first flow index table entry, wherein the first flow table includes a first flow table entry corresponding to the data packet;
fetching a second instruction corresponding to the data packet from the first flow table;
storing the second instruction in the cache buffer; and
processing the data packet based on the second instruction.

8. The method of claim 7, wherein for each of the first and second instructions, a type, length and data thereof are stored in the cache buffer.

9. The method of claim 7, wherein the second instruction is stored in the cache buffer when the second instruction is not redundant.

10. The method of claim 6, wherein whether the flow index table includes the first flow index table entry is determined by comparing a match entry of the data packet with a match entry of the first flow index table entry.
